(19) United States
(12) Patent Application Publication
(10) Pub. No.: US 2026/0233540 A1
(43) Pub. Date: Aug. 13, 2026

(54) RECORDING APPARATUS

(71) Applicant: SEIKO EPSON CORPORATION, TOKYO (JP)

(72) Inventors: Kohei OKAWA, MATSUMOTO-SHI (JP); Katsumi YAMADA, MATSUMOTO-SHI (JP); Hiroki SHINAGAWA, Shiojiri-shi (JP); Takumi WATANABE, MATSUMOTO-SHI (JP); Natori KADOTA, MATSUMOTO-SHI (JP)

(21) Appl. No.: 19/537,685

(22) Filed: Feb. 12, 2026

(30) Foreign Application Priority Data
Feb. 12, 2025 (JP) 2025-020579

(51) Int. Cl. B41J 13/10; B41J 2/165; B41J 13/03; B41J 25/00; B41J 29/00

(52) U.S. Cl. CPC B41J 13/10; B41J 2/16505; B41J 13/03; B41J 25/001; B41J 29/00; B41J 2002/16594; B41P 2235/27

(57) ABSTRACT

A recording apparatus includes a motor that is a common driving source for a first roller pair, a second roller pair, and a suction pump. A power transmission section transmits power to the suction pump when the motor reversely rotates. A blocking section that can be switched to a blocking state of blocking a conveyance path and an opening state of opening the conveyance path is provided between the first roller pair and the second roller pair. The blocking section takes the opening state when the motor rotates in a forward rotation direction and takes the blocking state when the motor rotates in a reverse rotation direction.

### CROSS REFERENCE TO RELATED APPLICATION

The present application is based on, and claims priority from JP Application Serial Number 2025-020579, filed Feb. 12, 2025, the disclosure of which is hereby incorporated by reference herein in its entirety.

### BACKGROUND

### 1. Technical Field

The present disclosure relates to a recording apparatus that performs recording on a medium.

### 2. Related Art

In a recording apparatus represented by an inkjet printer, a plurality of driving targets are sometimes driven by one motor in order to suppress an increase in cost. In the recording apparatus described in JP-A-2013-39805, an intermediate roller, a conveyance roller, a paper discharge roller, and a suction pump are driven by one motor. The intermediate roller rotates forward regardless of a rotation direction of the motor. The conveyance roller and the paper discharge roller rotate forward when the motor rotates forward and reversely rotate when the motor reversely rotates. The suction pump is driven only when the motor reversely rotates.

The recording apparatus described in JP-A-2013-39805 determines, in view of the fact that, when the motor is reversely rotated for driving the suction pump, the intermediate roller and the conveyance roller are likely to rotate in the opposite directions to each other to cause a jam, whether a PE sensor for detecting a paper end has detected a paper leading end at the time of the driving of the suction pump. The PE sensor is disposed in the front of the conveyance roller. When the PE sensor detects the paper leading end at the time of the driving of the suction pump, the motor is stopped.

Although the PE sensor is not disclosed in detail in JP-A-2013-39805, as the PE sensor, there is a non-contact type PE sensor that does not come into contact with a medium and a contact type PE sensor that comes into contact with a medium. In particular, the contact type PE sensor is sometimes adopted from the viewpoint of suppressing an increase in cost and suppressing erroneous detection. As an example of the contact type PE sensor, as described in JP-A-2004-352416, a lever capable of swinging in contact with a medium is sometimes used.

JP-A-2013-39805 and JP-A-2004-352416 are examples of the related art.

In the recording apparatus described in JP-A-2004-352416, a lever is configured to swing in contact with a medium conveyed from upstream to downstream and is not configured to swing in contact with a medium reversely fed from downstream to upstream. When the contact type PE sensor explained above is used, it is not only likely that the medium cannot be detected even if the leading end of the reversely fed medium comes into contact with the lever but also likely that a jam due to the leading end of the medium coming into contact with the lever is likely to occur.

In addition, when the PE sensor is not provided upstream of the conveyance roller in the first place, it is also likely that a medium cannot be detected and a jam occurs because the leading end of the medium comes into contact with a part other than the PE sensor upstream of the conveyance roller.

Therefore, it is desired to, without using the PE sensor disposed upstream of the conveyance roller, suppress a jam that occurs when the motor is reversely rotated for driving the suction pump.

### SUMMARY

According to an aspect of the present disclosure, there is provided a recording apparatus including: a conveyance path for conveying a medium; a recording head configured to perform recording on the medium in the conveyance path; a first roller pair provided upstream of the recording head in the conveyance path and configured to convey the medium; a second roller pair provided downstream of the recording head in the conveyance path and configured to convey the medium; a cap facing the recording head; a suction pump coupled to the cap; a motor that is a common driving source for the first roller pair, the second roller pair, and the suction pump; a power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction; and a blocking section provided between the first roller pair and the second roller pair in the conveyance path and switched to a blocking state of blocking the conveyance path and an opening state of opening the conveyance path, wherein the blocking section takes the opening state when the motor rotates in the forward rotation direction and takes the blocking state when the motor rotates in the reverse rotation direction.

### BRIEF DESCRIPTION OF THE DRAWINGS

FIG. 1 is an exterior perspective view of a printer.

FIG. 2 is a diagram illustrating a medium conveyance path of the printer.

FIG. 3 is a block diagram illustrating a control system of the printer.

FIG. 4 is a perspective view of a maintenance unit.

FIG. 5 is a perspective view of a power transmission section that transmits power from a conveyance motor to a suction pump.

FIG. 6 is a perspective view of a time lag mechanism.

FIG. 7 is a cross-sectional view of the time lag mechanism.

FIG. 8 is a diagram illustrating a state change of a lever configuring a medium detection section.

FIG. 9 is a diagram illustrating a part of the medium conveyance path.

FIG. 10 is a perspective view illustrating a blocking section.

FIG. 11 is an enlarged perspective view of sections.

FIG. 12 is an exploded perspective view of a configuration illustrated in FIG. 11.

FIG. 13 is a cross-sectional view of a roller support member and a facing section taken along a Y-Z plane and is a diagram illustrating an opening state and a blocking state of the blocking section.

FIG. 14 is a perspective view illustrating a blocking section according to another embodiment.

FIG. 15 is a cross-sectional view illustrating the blocking section with the facing section taken along an X-Z plane.

FIG. 16 is a cross-sectional view of the roller support member and the facing section taken along the Y-Z plane and is a diagram illustrating the opening state and the blocking state of the blocking section.

### DESCRIPTION OF EMBODIMENTS

The present disclosure is schematically explained below.

According to a first aspect of the present disclosure, there is provided a recording apparatus including: a conveyance path for conveying a medium; a recording head configured to perform recording on the medium in the conveyance path; a first roller pair provided upstream of the recording head in the conveyance path and configured to convey the medium; a second roller pair provided downstream of the recording head in the conveyance path and configured to convey the medium; a cap facing the recording head; a suction pump coupled to the cap; a motor that is a common driving source for the first roller pair, the second roller pair, and the suction pump; a power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction; and a blocking section provided between the first roller pair and the second roller pair in the conveyance path and switched to a blocking state of blocking the conveyance path and an opening state of opening the conveyance path, wherein the blocking section takes the opening state when the motor rotates in the forward rotation direction and takes the blocking state when the motor rotates in the reverse rotation direction.

When the trailing end of a discharged medium is located near the second roller pair or when a part of the discharged medium remains in the conveyance path, the medium is sometimes sent in the upstream direction of the conveyance path when the suction pump is caused to operate. This is because it is necessary to rotate the motor in the reverse rotation direction in order to cause the suction pump to operate. As a result, a jam sometimes occurs.

According to this aspect, it is possible to prevent, with the blocking section, the medium from being sent upstream of the conveyance path when the motor is rotated in the reverse rotation direction and it is possible to suppress occurrence of a jam. Since the blocking section takes the opening state when the motor rotates in the forward rotation direction, it is possible to prevent the blocking section from getting in the way when the medium is conveyed downstream of the conveyance path.

A second aspect is an aspect dependent from the first aspect, wherein the blocking section taking the blocking state blocks the medium between the recording head and the first roller pair in the conveyance path.

If the blocking section taking the blocking state is provided between the second roller pair and the recording head in the conveyance path, the blocking section sometimes cannot stop the medium. However, according to this aspect, the blocking section taking the blocking state blocks the medium between the recording head and the first roller pair in the conveyance path. For this reason, it is possible to more securely stop the medium sent upstream of the conveyance path.

A third aspect is an aspect dependent from the second aspect, wherein the first roller pair includes a drive roller to which power is transmitted and a driven roller that is driven to rotate while nipping the medium between the driven roller and the drive roller, and the blocking section includes a flap that obtains torque from the drive roller or the driven roller and rotates to switch the opening state and the blocking state.

According to this aspect, the blocking section includes the flap that obtains torque from the drive roller or the driven roller and rotates to switch the opening state and the blocking state. For this reason, it is possible to switch the opening state and the blocking state with a simple configuration.

A fourth aspect is an aspect dependent from the third aspect, wherein the flap is disposed side by side with the driven roller along a rotation axis of the driven roller and obtains torque from the driven roller and rotates.

Since the drive roller is a roller to which power is transmitted, the drive roller is more easily limited in a disposition position and the number of disposed rollers than the driven roller. According to this aspect, the flap is disposed side by side with the driven roller along the rotation axis of the driven roller and obtains torque from the driven roller and rotates. For this reason, a degree of freedom of a disposition position and the number of disposed rollers is improved as compared with a configuration of receiving power from the drive roller and rotating.

A fifth aspect is an aspect dependent from the fourth aspect, the recording apparatus further including a support member configured to support the driven roller, wherein the flap is provided in the support member.

According to this aspect, since the flap is provided in the support member that supports the driven roller, a dedicated component for providing the flap is unnecessary and it is possible to suppress an increase in cost.

A sixth aspect is an aspect dependent from the fifth aspect, the recording apparatus further including: a rotating member configured to rotate integrally with the driven roller and including a flange section; and a spring member provided between the flap and the rotating member in a direction along the rotation axis, wherein the flap receives torque from the driven roller via the spring member.

According to this aspect, it is possible to easily implement a configuration in which the flap receives torque from the driven roller.

A seventh aspect is an aspect dependent from any one of the fourth to sixth aspects, wherein the flap does not come into contact with the drive roller.

When the flap comes into contact with the drive roller, it is likely that at least one of the flap and the drive roller wears. However, according to this aspect, since the flap does not come into contact with the drive roller, it is possible to suppress wear of the flap and the drive roller.

An eighth aspect is an aspect dependent from any one of the fourth to sixth aspects, the recording apparatus further including a facing section having a support surface that supports the medium, the facing section being provided at a position facing the recording head, wherein the flap comes into contact with the support surface to take the blocking state when the motor rotates in the reverse rotation direction.

According to this aspect, since the flap comes into contact with the support surface to take the blocking state when the motor rotates in the reverse rotation direction, it is possible to guide, in a direction away from the support surface, the medium sent upstream of the conveyance path. As a result, it is possible to prevent the trailing end of the medium from being nipped by the first roller pair and being further sent upstream of the conveyance path.

This aspect may be dependent from the seventh aspect without being limited to any one of the fourth to sixth aspects.

A ninth aspect is an aspect dependent from the second aspect, wherein the blocking section includes a fence that moves in a direction intersecting the conveyance path to switch the opening state and the blocking state.

According to this aspect, the blocking section includes a fence that moves in the direction intersecting the conveyance path to switch the opening state and the blocking state. For this reason, it is possible to switch the opening state and the blocking state with a simple configuration.

A tenth aspect is an aspect dependent from the ninth aspect, the recording apparatus further including: a carriage movable in a width direction intersecting the conveyance direction of the medium and including the recording head; and a slide member configured to receive an external force moving in the width direction from the carriage when the carriage moves to an outer side of a recording region where recording is performed on the medium, wherein the fence retracts to below the conveyance path to take the opening state and rises from below the conveyance path to take the blocking state, a cam section that pushes up the fence is provided in the slide member, and, when the slide member moves in a first direction in the width direction, the cam section pushes up the fence to switch the fence from the opening state to the blocking state and, when the slide member moves in a second direction opposite to the first direction, the cam section releases the push-up of the fence to switch the fence from the blocking state to the opening state.

According to this aspect, since the fence switches to the opening state and the blocking state according to the operation of the carriage, a dedicated power source for raising and lowering the fence is unnecessary and it is possible to suppress an increase in cost of the apparatus.

Hereinafter, the present disclosure is specifically explained.

An inkjet printer 1 that ejects ink, which is an example of liquid, to perform recording on a medium represented by recording paper is explained below as an example of a recording apparatus. The inkjet printer 1 is hereinafter abbreviated as printer 1.

An X-Y-Z coordinate system illustrated in the figures is an orthogonal coordinate system. A Y-axis direction is a conveyance direction of the medium at the time of recording and is the apparatus depth direction. In the present embodiment, among side surfaces forming the periphery of the printer 1, a side surface on a +Y direction side is a front surface and a side surface on a -Y direction side is a back surface.

An X-axis direction is the apparatus width direction and a +X direction side is the left side and a -X direction side is the right side when viewed from an operator of the printer 1. The X-axis direction is the medium width direction.

A Z-axis direction is the vertical direction, that is, the apparatus height direction and a +Z direction is the upward direction and a -Z direction is the downward direction.

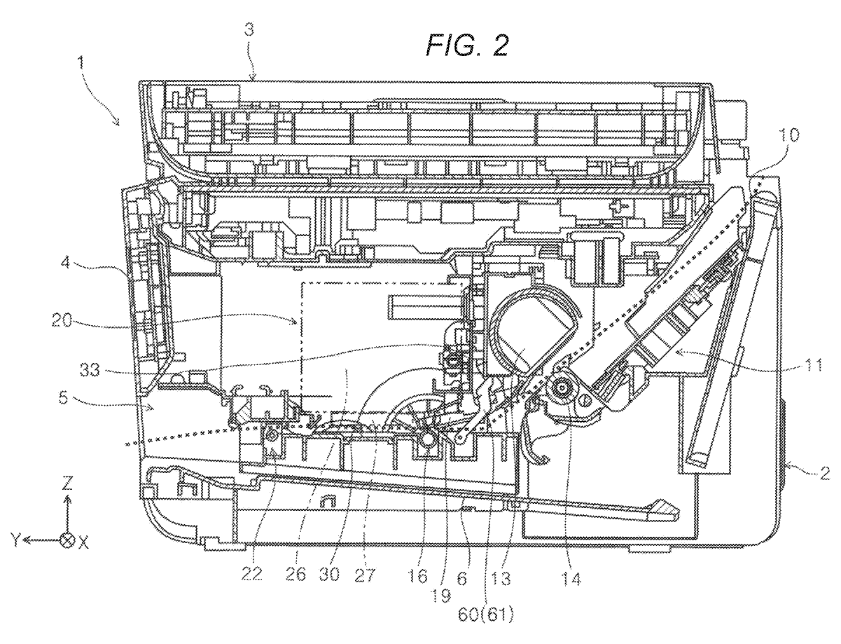

Hereinafter, a direction in which the medium is sent is sometimes referred to as "downstream" and the opposite direction thereof is sometimes referred to as "upstream". In FIG. 2, a conveyance path 10 of the medium is indicated by a broken line. In the printer 1, the medium is conveyed through the conveyance path 10.

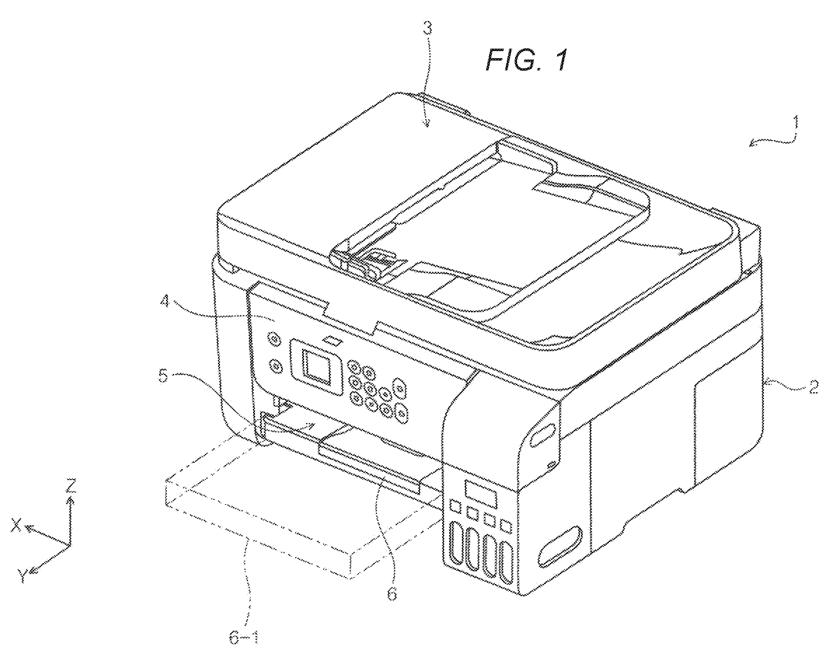

As illustrated in FIGS. 1 and 2, the printer 1 is configured as a multifunction peripheral including a recording unit 2 and a scanner section 3 disposed above the recording unit 2. An operation panel 4 is provided on the apparatus front side of the recording unit 2.

A discharge port 5 is formed on the front side of the recording unit 2. A medium receiving tray 6 is provided in the discharge port 5. The medium receiving tray 6 is configured to be capable of switching a housed state (a solid line in FIG. 1) and a pulled-out state (an alternate long and two-short dashes line indicated by reference sign 6-1 in FIG. 1) with respect to the recording unit 2.

As illustrated in FIG. 2, a medium support section 11 that supports, in an inclined posture, the medium to be fed is provided upstream of the conveyance path 10. The medium in the present embodiment includes, for example, media having different sizes such as A4 size paper and B5 size paper, photographic paper, or a postcard.

The medium supported by the medium support section 11 is nipped by a feeding roller 13 and a separation roller 14 and sent toward a conveyance roller pair 16. The conveyance roller pair 16 is an example of a first conveyance roller pair provided upstream of a recording head 27 in the conveyance path 10.

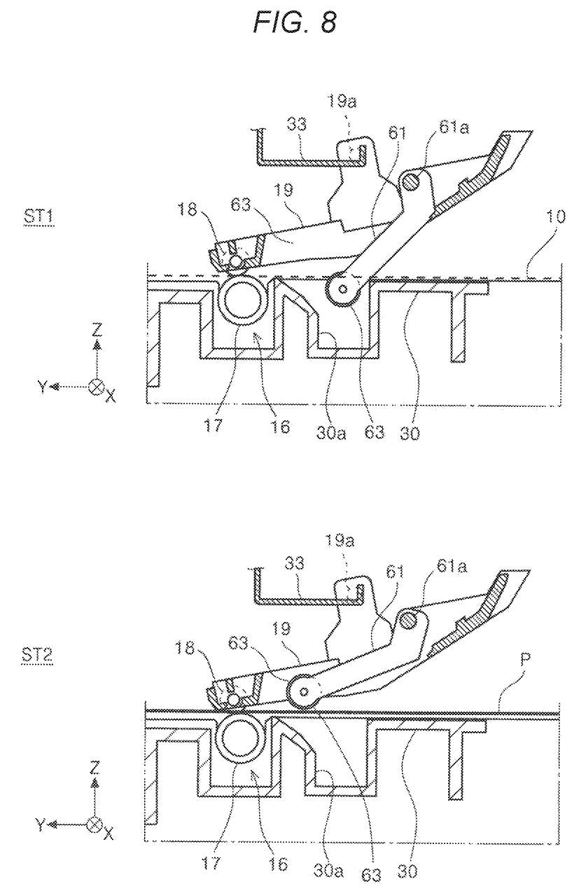

As illustrated in FIG. 8, the conveyance roller pair 16 includes a conveyance drive roller 17 that is rotationally driven and a conveyance driven roller 18 that nips the medium between the conveyance driven roller 18 and the conveyance drive roller 17. As illustrated in FIG. 8, the conveyance driven roller 18 is rotatably supported by a roller support member 19.

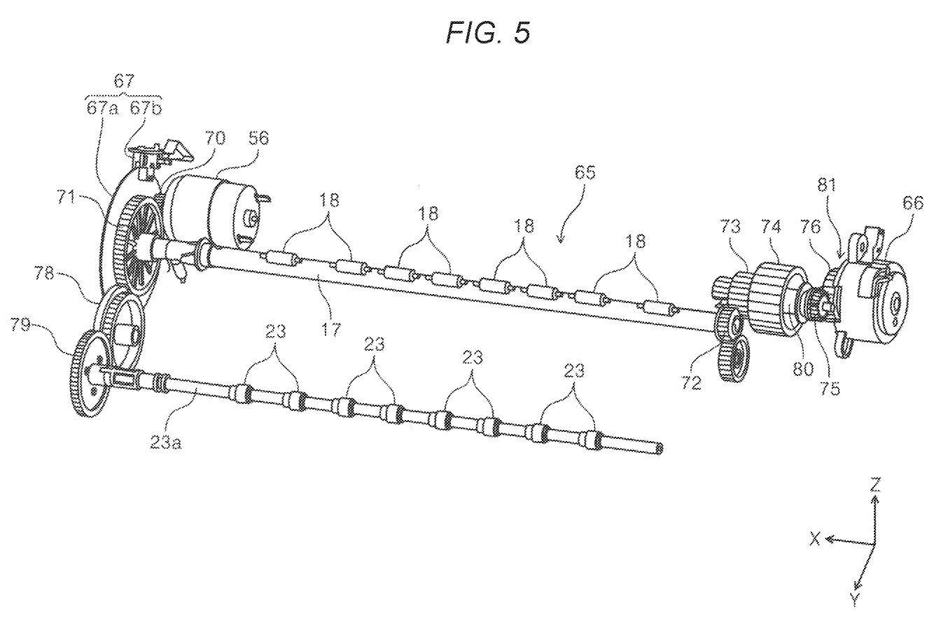

In the present embodiment, the conveyance drive roller 17 is a shaft extended in the X-axis direction as illustrated in FIG. 5. In the present embodiment, as illustrated in FIG. 5, a plurality of conveyance driven rollers 18 are provided at appropriate intervals in the X axis direction with respect to the conveyance drive roller 17.

In FIG. 8, the roller support member 19 is attached to a frame 33 via a swing shaft 19a and swings via the swing shaft 19a, whereby the conveyance driven roller 18 advances and retracts with respect to the conveyance drive roller 17. The roller support member 19 is pressed by a pressing member not illustrated in FIG. 8, for example, a torsion spring or an extension spring in a direction in which the conveyance driven roller 18 advances with respect to the conveyance drive roller 17.

Returning back to FIG. 2, a recording section 20 includes a carriage 26 and a recording head 27. The carriage 26 is configured to be capable of reciprocating in the X-axis direction. The recording head 27 is provided below the carriage 26. In the recording head 27, a plurality of ink ejection nozzles (not illustrated) capable of ejecting ink in the -Z direction are provided.

A facing section 30 that supports the medium is provided at a position that can face the recording head 27. The facing section 30 specifies the distance between the medium and the recording head 27. The recording head 27 ejects the ink to the medium supported by the facing section 30 to execute recording on a recording surface of the medium. The medium on which the recording has been executed is nipped by a discharge roller pair 22 disposed downstream of the recording head 27 in the conveyance path 10 and is discharged toward the medium receiving tray 6.

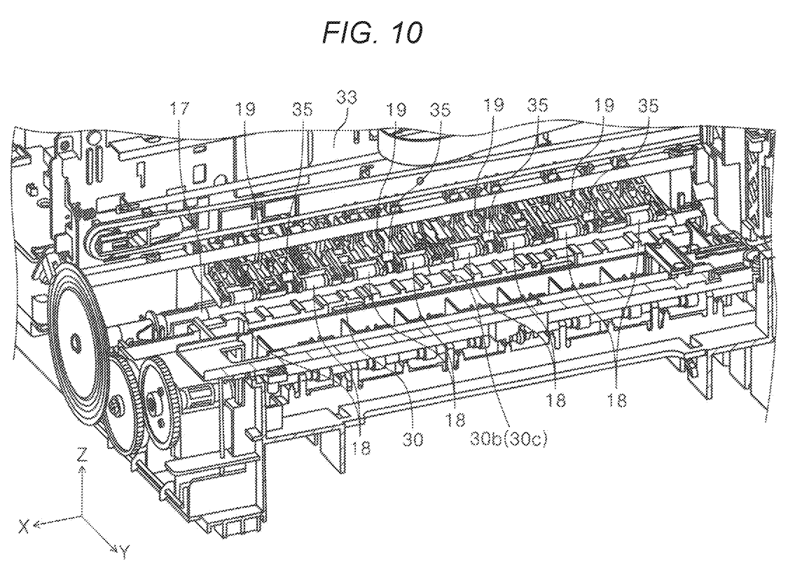

As illustrated in FIG. 10, the facing section 30 includes, at appropriate intervals in the medium width direction, a plurality of ribs 30b that support the medium and extend in the conveyance direction. The upper surface of the rib 30b forms a support surface 30c that supports the medium.

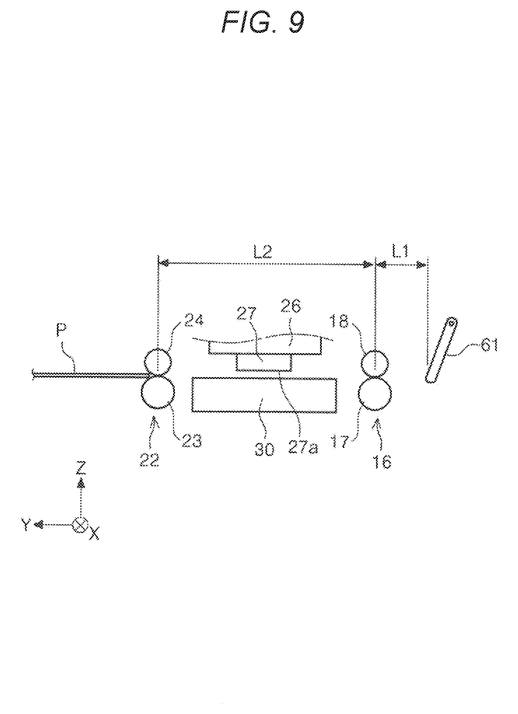

The discharge roller pair 22 is an example of a second roller pair that is provided downstream of the recording head 27 in the conveyance path 10 and conveys the medium. As illustrated in FIG. 9, the discharge roller pair 22 includes a discharge drive roller 23 that is rotationally driven and a discharge driven roller 24 that nips the medium between the discharge driven roller 24 and the discharge drive roller 23.

In the present embodiment, a plurality of pairs of the discharge drive roller 23 and the discharge driven roller 24 are provided at appropriate intervals in the X-axis direction. In the present embodiment, the discharge driven roller 24 is a toothed roller having teeth on the outer circumference thereof. The discharge driven roller 24 is capable of advancing and retracting with respect to the discharge drive roller 23 and nips the medium between the discharge driven roller 24 and the discharge drive roller 23 by using a not-illustrated bar spring as a rotary shaft.

In the present embodiment, a nip force for nipping the medium with the conveyance roller pair 16 is stronger than a nip force for nipping the medium with the discharge roller pair 22. Non-feeding of the medium in the conveyance roller pair 16 hardly occurs.

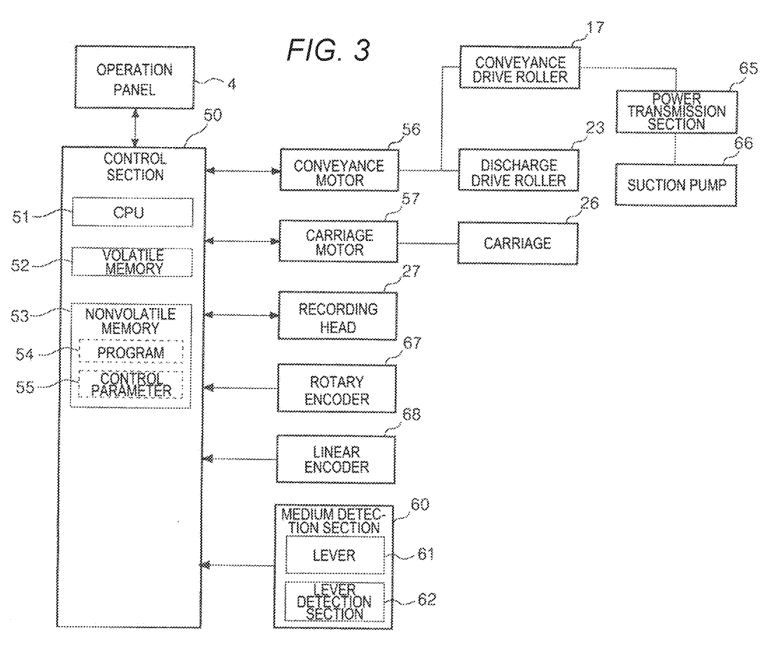

Next, a control system of the printer 1 is explained with reference to FIG. 3. In FIG. 3, only components necessary for the following explanation are illustrated and other components are not illustrated.

A control section 50 performs various kinds of control for the printer 1. The operation panel 4, a conveyance motor 56, a carriage motor 57, the recording head 27, a rotary encoder 67, a linear encoder 68, and a medium detection section 60 are connected to the control section 50.

The motors described above are, for example, DC motors. The control section 50 includes a driver circuit (not illustrated) for driving the motors.

The conveyance motor 56 is a common driving source for the conveyance drive roller 17, the discharge drive roller 23, and a suction pump 66. The suction pump 66 receives power from the conveyance motor 56 via a power transmission section 65 explained below.

Hereinafter, a rotation direction of the conveyance motor 56 at the time when the medium is conveyed in the +Y direction, that is, downstream is referred to as forward rotation direction and the opposite direction of the forward rotation direction is referred to as reverse rotation direction. As explained in detail below, when the conveyance motor 56 rotates in the forward rotation direction, the conveyance drive roller 17 and the discharge drive roller 23 rotate forward, power is not transmitted to the suction pump 66, and the suction pump 66 does not operate. When the conveyance motor 56 rotates in the reverse rotation direction, the conveyance drive roller 17 and the discharge drive roller 23 reversely rotate, power is transmitted to the suction pump 66, and the suction pump 66 operates.

The carriage motor 57 is a driving source for the carriage 26.

The rotary encoder 67 detects the rotation of the conveyance drive roller 17. The control section 50 can detect the rotation direction, the rotation amount, and the rotation speed of the conveyance motor 56 based on an output signal of the rotary encoder 67.

The linear encoder 68 detects the position of the carriage 26. The control section 50 can detect the position and the moving speed of the carriage 26 based on an output signal of the linear encoder 68.

The medium detection section 60 detects passage of the leading end and the trailing end of the medium upstream of the conveyance roller pair 16 in the conveyance path 10.

The medium detection section 60 includes a lever 61 that swings in contact with the medium and a lever detection section 62 that detects the swing of the lever 61. As illustrated in FIG. 8, the lever 61 is provided to be capable of swinging with respect to the roller support member 19 via a swing shaft 61a. A driven roller 63 is provided at the tip of the lever 61 and frictional resistance at the time when the medium comes into contact with the lever 61 is reduced.

A recess 30a is provided in the facing section 30. In a state in which the lever 61 is not in contact with the medium, as indicated by a state ST1 in FIG. 8, the tip of the lever 61 enters the recess 30a and comes into contact with the edge in the -Y direction of the recess 30a to block the conveyance path 10. The lever 61 is pressed by a not-illustrated pressing member, for example, a torsion spring to maintain the state ST1 in FIG. 8.

The lever 61 is pushed up by the medium conveyed in the +Y direction, that is, from upstream to downstream and swings as indicated by a change from the state ST1 to a state ST2 in FIG. 8. Even when the medium conveyed in the -Y direction, that is, from downstream to upstream comes into contact with the lever 61, since the lever 61 comes into contact with the edge in the -Y direction of the recess 30a, the lever 61 cannot swing.

The lever detection section 62 (FIG. 3) can detect the swing, that is, the posture change of the lever 61. The control section 50 can detect the passage of the leading end and the trailing end of the medium based on a signal change of the lever detection section 62.

Returning back to FIG. 3, the control section 50 controls display of the operation panel 4, receives information transmitted from the operation panel 4, and performs various kinds of control.

The control section 50 includes a central processing Unit (CPU) 51 that performs execution processing of a computer program, in other words, software, a volatile memory 52, and a nonvolatile memory 53.

The CPU 51 performs various arithmetic operations necessary in executing programs 54 stored in the nonvolatile memory 53. The volatile memory 52 is used as a work area used by the CPU 51 when executing the programs 54 and a temporary data storage area. In the nonvolatile memory 53, the programs 54 and control parameters 55 necessary in executing the programs 54 are stored. The programs 54 include a program for executing various kinds of processing explained below. The control parameters 55 include parameters for executing the programs 54.

Various kinds of processing in the printer 1 are implemented by the control section 50 executing the programs 54.

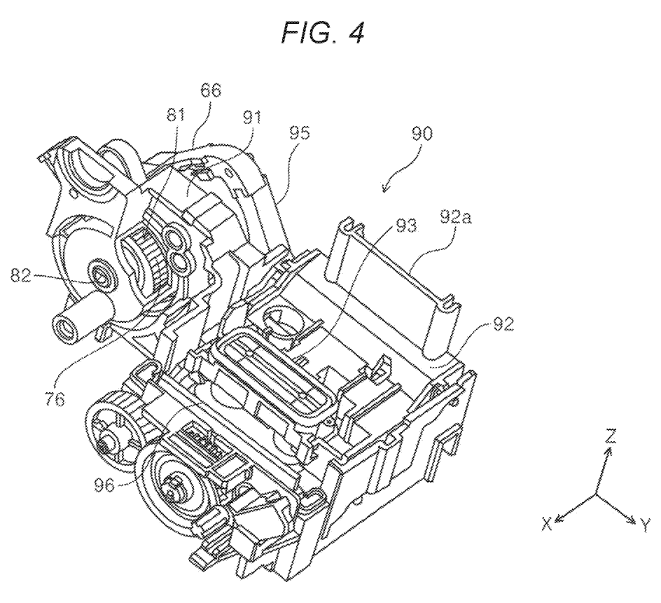

Next, a maintenance unit 90 including the suction pump 66 is explained with reference to FIGS. 4 to 7.

As illustrated in FIG. 4, the maintenance unit 90 includes a unit frame 91 as a base body. Elements such as the suction pump 66 and a slide base 92 are provided in the unit frame 91.

The slide base 92 is capable of sliding in the X-axis direction with respect to the unit frame 91 and is provided to be displaceable in the +Z direction as the slide base 92 slides in the -X direction. The slide base 92 is pressed in the +X direction by a not-illustrated spring.

A cap 93 is provided in the slide base 92.

The maintenance unit 90 is provided at the end portion in the -X direction inside the apparatus. When the carriage 26 moves to the end portion in the -X direction, the recording head 27 can face the cap 93.

An engaging section 92a is provided in the slide base 92. The carriage 26 is capable of coming into contact with the engaging section 92a. At a stage when the carriage 26 moves in the -X direction and comes into contact with the engaging section 92a, a gap is formed between a head surface 27a (see FIG. 9) of the recording head 27 and the cap 93. The position of the carriage 26 at this time is set as a cap facing position.

When the carriage 26 further moves in the -X direction from the cap facing position, the slide base 92 moves in the -X direction together with the carriage 26. Accordingly, the cap 93 rises and the cap 93 comes into close contact with the head surface 27a (see FIG. 9) of the recording head 27. The position of the carriage 26 at this time is set as a cap close contact position.

At a printing standby time, the carriage 26 is located at the cap close contact position. In processing of eliminating nozzle clogging of the recording head 27, the suction pump 66 is driven in a state in which the carriage 26 is located at the cap close contact position. The cap 93 and the suction pump 66 are connected by a tube 95 and a negative pressure is formed in the cap 93 by the operation of the suction pump 66.

At a flushing operation time, the ink is ejected from the recording head 27 to the cap 93 in a state in which the carriage 26 is located at the cap facing position. When the ink accumulates in the cap 93 accordingly, the suction pump 66 is driven to suck the ink in the cap 93.

The ink sucked by the suction pump 66 is sent to a not-illustrated waste ink storage section.

A wiper 96 is provided in the slide base 92. When the carriage 26 moves in the -X direction, the head surface 27a is wiped by the wiper 96.

A time lag mechanism 81 is provided in the unit frame 91. As explained in detail below, the time lag mechanism 81 configures a power transmission section 65 (see FIG. 5) explained below. The time lag mechanism 81 is a mechanism that provides a time lag in power transmission after the rotation of the conveyance motor 56 is switched from the forward rotation direction to the reverse rotation direction. Accordingly, even when the rotation of the conveyance motor 56 is switched from the forward rotation direction to the reverse rotation direction, the suction pump 66 does not immediately operate and a time lag occurs until the suction pump 66 starts the operation.

FIG. 5 illustrates a power transmission section 65 that transmits power from the conveyance motor 56 to the suction pump 66. The conveyance motor 56 is provided near the end portion in the +X direction of the conveyance drive roller 17. A gear 70 is provided in a motor shaft of the conveyance motor 56 and power is transmitted from the gear 70 to a gear 71. The gear 71 is a gear provided at the end portion in the +X direction of the conveyance drive roller 17. A gear 78 meshes with the gear 71. The gear 78 meshes with a gear 79. The gear 79 is a gear provided at the +X direction end portion of a rotary shaft 23a of the discharge drive roller 23. With the configuration explained above, power is transmitted from the conveyance motor 56 to the conveyance drive roller 17 and the discharge drive roller 23.

A rotary scale 67a is provided in the gear 71. The rotary scale 67a enters a detection section 67b. The rotary scale 67a and the detection section 67b configure the rotary encoder 67.

A gear 72 is provided at the end portion in the -X direction of the conveyance drive roller 17 and power is transmitted from the gear 72 to a gear 73. The gear 73 and a gear 74 are integrally configured and power is transmitted from the gear 74 to the feeding roller 13 (see FIG. 2) via a not-illustrated gear.

A one-way clutch (not illustrated) is provided on the inside of the gear 74. With a function of the one-way clutch, power is transmitted from the gear 74 to a shaft 80 only when the conveyance motor 56 rotates in the reverse rotation direction. A one-way clutch may be provided on the inside of the suction pump 66.

A gear 75 is provided in the shaft 80. Power is transmitted from the gear 75 to a gear 76 configuring the time lag mechanism 81.

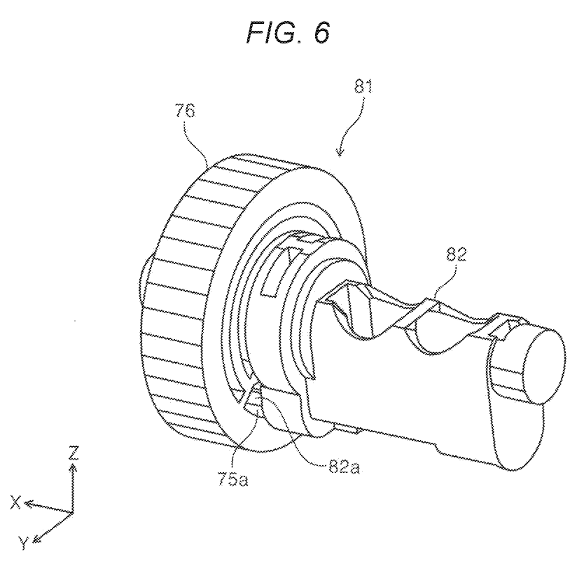

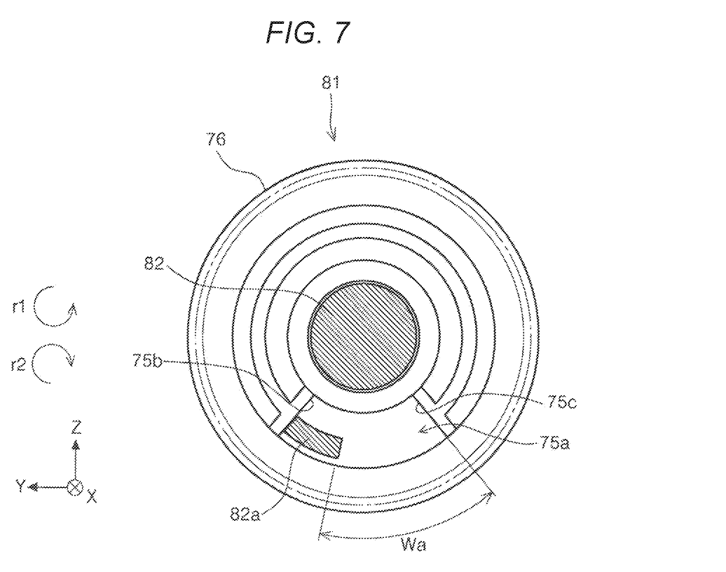

As illustrated in FIG. 6, the time lag mechanism 81 includes the gear 76 and a transmission shaft 82 that transmits power to the suction pump 66. As illustrated in FIG. 7 as well, a groove 75a extending in the circumferential direction is formed in the gear 76. A boss section 82a is formed in the transmission shaft 82. The boss section 82a enters the groove 75a. A first inner wall 75b and a second inner wall 75c are formed on the inner side of the groove 75a.

In FIG. 7, a rotation direction r1 is a rotation direction of the gear 76 at the time when the conveyance motor 56 rotates in the forward rotation direction. When the conveyance motor 56 rotates in the forward rotation direction, the gear 76 rotates in the rotation direction r1. Accordingly, the boss section 82a comes into contact with the first inner wall 75b of the groove 75a and the transmission shaft 82 rotates in the rotation direction r1.

When the conveyance motor 56 rotates in the reverse rotation direction from this state, the gear 76 rotates in a rotation direction r2. However, power is not transmitted to the transmission shaft 82 until the boss section 82a comes into contact with the second inner wall 75c of the groove 75a. Accordingly, the time lag explained above occurs. In FIG. 7, reference sign Wa denotes a rotation amount of the gear 76 until the boss section 82a comes into contact with the second inner wall 75c of the groove 75a.

The above is the configuration of the power transmission section 65. Hereinafter, a jam that occurs when the conveyance motor 56 rotates in the reverse rotation direction is explained.

When determining that it is cap suction timing, the control section 50 causes the suction pump 66 to operate. Here, the cap suction is processing of sucking the ink accumulated in the cap 93 (see FIG. 4) by a flushing operation. The control section 50 grasps a total amount of ink ejected to the cap 93 by the flushing operation and performs the cap suction when the total amount exceeds a predetermined value. The cap suction is performed, for example, at the end of a print job but is not limited thereto and may be performed when power is turned off.

Here, when the suction pump 66 is caused to operate when the trailing end of a discharged medium is located near the discharge roller pair 22 as illustrated in FIG. 9 or when a part of the discharged medium remains in the conveyance path 10, the medium is sometimes sent in the upstream direction of the conveyance path 10. This is because it is necessary to rotate the conveyance motor 56 in the reverse rotation direction in order to cause the suction pump 66 to operate. As a result, it is likely that a jam occurs. In particular, upstream of the conveyance roller pair 16 is a deep position of the apparatus. When the medium conveyed in the upstream direction is nipped again by the conveyance roller pair 16 and is further sent upstream and a jam occurs, it is likely that jam processing is difficult. As explained with reference to FIG. 8, the lever 61 configuring the medium detection section 60 does not swing even if the medium conveyed upstream comes into contact with the lever 61. For this reason, when the medium conveyed in the upstream direction is nipped again by the conveyance roller pair 16 and further sent upstream, it is highly likely that a jam occurs.

In FIG. 9, a distance L1 is a path length between the conveyance roller pair 16 and the lever 61 and a distance L2 is a path length between the conveyance roller pair 16 and the discharge roller pair 22. The distance L1 is shorter than the distance L2.

Hereinafter, a blocking section for suppressing the jam explained above is explained.

FIGS. 10 to 13 illustrate a blocking section according to a first embodiment. The blocking section according to the first embodiment includes a flap 35.

The flap 35 is an example of a blocking section that is provided between the conveyance roller pair 16 and the discharge roller pair 22 in the conveyance path 10 and can be switched to a blocking state of blocking the conveyance path 10 and an opening state of opening the conveyance path 10.

As illustrated in FIG. 10, a plurality of flaps 35 are provided at intervals in the medium width direction.

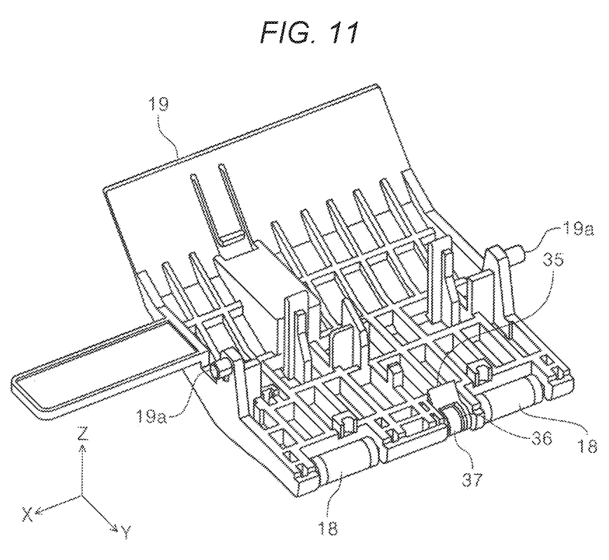

In the present embodiment, the flap 35 is provided in the roller support member 19 as illustrated in FIG. 11. In the present embodiment, one flap 35 is provided for one roller support member 19 as illustrated in FIG. 11.

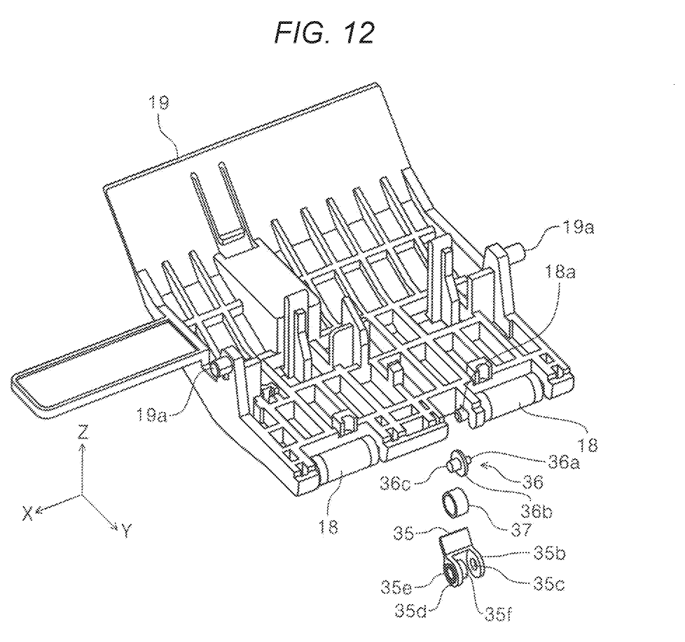

As illustrated in FIG. 12, the flap 35 includes a first base 35b and a second base 35d. A first fitting hole 35c is formed in the first base 35b, and a second fitting hole 35e and a cylindrical section 35f are formed in the second base 35d. A rotating member 36 is disposed between the first base 35b and the second base 35d.

A rotary shaft section 18a is provided in the conveyance driven roller 18. The conveyance driven roller 18 is rotatably supported by the roller support member 19 via the rotary shaft section 18a.

The rotary shaft section 18a is formed in a cylindrical shape. A first fitting shaft 36a of the rotating member 36 can fit to the rotary shaft section 18a. Accordingly, the rotating member 36 rotates integrally with the conveyance driven roller 18.

The rotating member 36 further includes a flange section 36b and a second fitting shaft 36c. The flange section 36b of the rotating member 36 is disposed between the first base 35b and the second base 35d.

At this time, the first fitting shaft 36a fits to the rotary shaft section 18a through the first fitting hole 35c and the second fitting shaft 36c fits in the second fitting hole 35e.

Reference numeral 37 denotes a compression coil spring. The compression coil spring 37 fits to the cylindrical section 35f and exerts a spring force between the flange section 36b of the rotating member 36 and the second base 35d. That is, the torque of the rotating member 36 can be transmitted to the second base 35d, that is, the flap 35 via the compression coil spring 37.

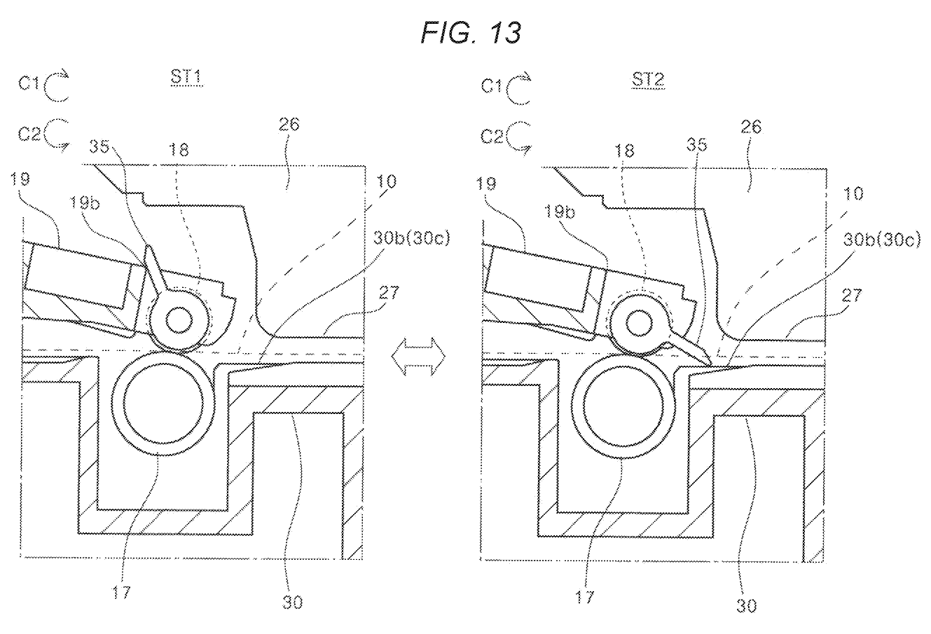

In FIG. 13, when the conveyance motor 56 rotates in the forward rotation direction, the conveyance driven roller 18 rotates in a rotation direction C2 according to rotation of the conveyance drive roller 17 in a rotation direction C1. When the conveyance motor 56 rotates in the reverse rotation direction, the conveyance driven roller 18 rotates in the rotation direction C1 according to rotation of the conveyance drive roller 17 in the rotation direction C2.

Accordingly, the flap 35 rotates in the rotation direction C2 when the conveyance motor 56 rotates in the forward rotation direction and rotates in the rotation direction C1 when the conveyance motor 56 rotates in the reverse rotation direction.

When the flap 35 rotates in the rotation direction C2, as indicated by the state ST1 in FIG. 13, the flap 35 comes into contact with a restricting section 19b of the roller support member 19 and this state is maintained. This state is an opening state in which the flap 35 opens the conveyance path 10.

When the flap 35 rotates in the rotation direction C1, as indicated by the state ST2 in FIG. 13, the flap 35 comes into contact with the support surface 30c of the facing section 30 and this state is maintained. This state is a blocking state in which the flap 35 blocks the conveyance path 10.

As explained above, the flap 35 is provided between the conveyance roller pair 16 and the discharge roller pair 22 in the conveyance path 10 and can be switched to the blocking state of blocking the conveyance path 10 and the opening state of opening the conveyance path 10. The flap 35 takes the opening state when the conveyance motor 56 rotates in the forward rotation direction and takes the blocking state when the conveyance motor 56 rotates in the reverse rotation direction.

Accordingly, when the conveyance motor 56 is rotated in the reverse rotation direction in order to cause the suction pump 66 to operate, it is possible to prevent the medium from being unintentionally sent upstream of the conveyance path 10, in particular, further upstream than the conveyance roller pair 16 to cause a jam.

Since the flap 35 takes the opening state when the conveyance motor 56 rotates in the forward rotation direction, it is possible to prevent the flap 35 from getting in the way when the medium is conveyed downstream of the conveyance path 10.

In the present embodiment, the flap 35 taking the blocking state blocks the medium between the recording head 27 and the conveyance roller pair 16 in the conveyance path 10.

Here, if the flap 35 taking the blocking state is provided between the discharge roller pair 22 and the recording head 27 in the conveyance path 10, the flap 35 sometimes cannot stop the medium. However, in the present embodiment, the flap 35 taking the blocking state blocks the medium between the recording head 27 and the conveyance roller pair 16 in the conveyance path 10. For this reason, it is possible to more securely stop the medium sent upstream of the conveyance path 10.

However, the flap 35 may be provided between the discharge roller pair 22 and the recording head 27.

Further, in the present embodiment, the flap 35 obtains torque from the conveyance driven roller 18 and rotates to switch the opening state and the blocking state. For this reason, the flap 35 can switch the opening state and the blocking state with a simple configuration.

However, the flap 35 may obtain torque from the conveyance drive roller 17 and rotate.

In the present embodiment, the flap 35 is disposed side by side with the conveyance driven roller 18 along the rotation axis of the conveyance driven roller 18 and obtains torque from the conveyance driven roller 18 and rotates. In the present embodiment, the rotation axis of the conveyance driven roller 18 is parallel to the X axis.

Here, since the conveyance drive roller 17 is a roller to which power is transmitted, the conveyance drive roller 17 is more easily limited in a disposition position and the number of disposed rollers compared with the conveyance driven roller 18. In view of such a problem, the flap 35 according to the present embodiment is disposed side by side with the conveyance driven roller 18 along the rotation axis of the conveyance driven roller 18 and obtains torque from the conveyance driven roller 18 and rotates. For this reason, a degree of freedom of a disposition position and the number of disposed rollers of the flap 35 is improved.

In the present embodiment, the flap 35 is provided in the roller support member 19. Accordingly, a dedicated component for providing the flap 35 is unnecessary and it is possible to suppress an increase in cost.

In the present embodiment, the inkjet printer 1 includes the rotating member 36 including the flange section 36b and the compression coil spring 37. The flap 35 receives torque from the conveyance driven roller 18 via the compression coil spring 37. The rotating member 36 is a member that rotates integrally with the conveyance driven roller 18. The compression coil spring 37 is a spring member provided between the second base 35d of the flap 35 and the rotating member 36 in the direction along the rotation axis. Therefore, it is possible to easily implement a configuration in which the flap 35 receives torque from the conveyance driven roller 18.

In the present embodiment, the flap 35 does not come into contact with the conveyance drive roller 17. When the flap 35 comes into contact with the conveyance drive roller 17, it is likely that at least one of the flap 35 and the conveyance drive roller 17 wear. However, according to the present embodiment, since the flap 35 does not come into contact with the conveyance drive roller 17, it is possible to suppress wear of the flap 35 and the conveyance drive roller 17.

When the conveyance motor 56 rotates in the reverse rotation direction, the flap 35 comes into contact with the support surface 30c of the facing section 30 to take the blocking state. Accordingly, the medium sent upstream of the conveyance path 10 can be guided in a direction away from the support surface 30c. As a result, it is possible to prevent the trailing end of the medium from being nipped by the conveyance roller pair 16 and being further sent upstream of the conveyance path 10.

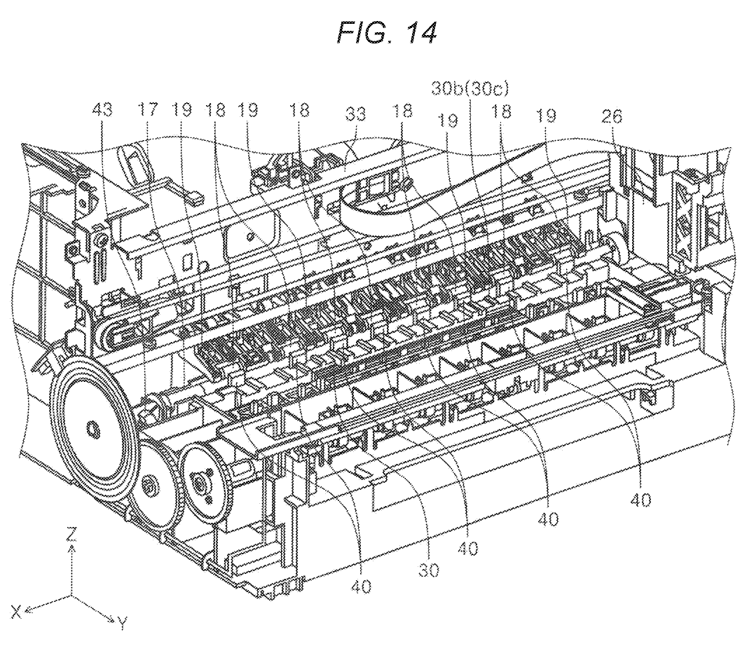

FIGS. 14 to 16 illustrate a blocking section according to a second embodiment. The blocking section according to the second embodiment includes a fence 40.

The fence 40 is an example of a blocking section that is provided between the conveyance roller pair 16 and the discharge roller pair 22 in the conveyance path 10 and can be switched to a blocking state of blocking the conveyance path 10 and an opening state of opening the conveyance path 10.

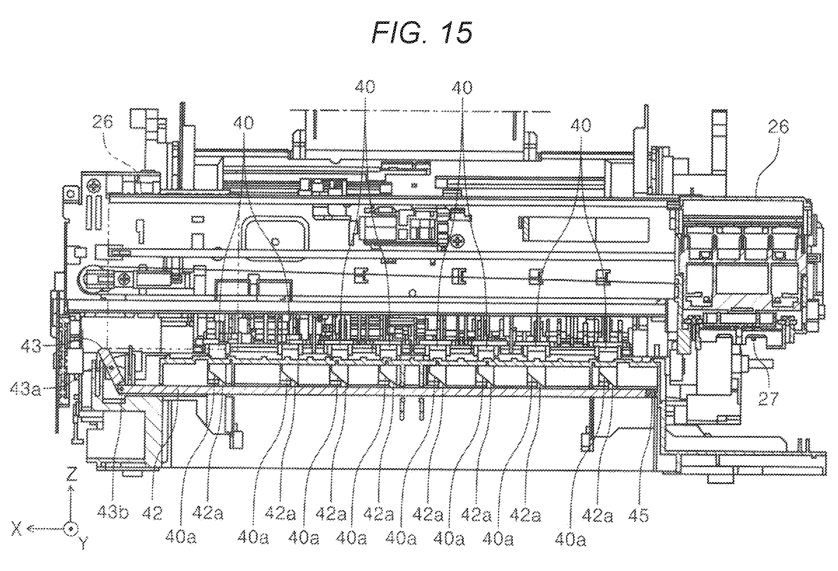

As illustrated in FIGS. 14 and 15, a plurality of fences 40 are provided at intervals in the medium width direction. In the present embodiment, the fence 40 is provided in the facing section 30.

More specifically, the fence 40 is provided to be capable of sliding in the Z-axis direction in the facing section 30.

As illustrated in FIG. 15, the lower end portion of the fence 40 is formed in an inclined shape on the surface in the +X direction and is formed as a cam follower section 40a.

In the facing section 30, a slide member 42 is provided in the -Z direction with respect to the fence 40. The slide member 42 is formed in a shape extending in the X-axis direction and is provided to be capable of sliding along the X-axis direction. A compression coil spring 45, which is an example of a pressing member, is provided in the -X direction with respect to the slide member 42 and presses the slide member 42 in the +X direction.

In the slide member 42, a cam section 42a is provided at a position where the cam section 42a is capable of engaging with the slide member 42. The cam section 42a pushes up the fence 40 in the +Z direction via the cam follower section 40a according to the sliding of the slide member 42.

A lever 43 is provided at the end portion in the +X direction in the facing section 30. The lever 43 is disposed on the outer side of a medium conveyance region in the medium width direction. The lever 43 is capable of swinging on the X-Z plane centering on a swing shaft 43a and is coupled to the slide member 42 via a coupling shaft 43b to be capable of turning relatively to the slide member 42. Accordingly, when the lever 43 turns in the counterclockwise direction in FIG. 15, the slide member 42 slides in the -X direction and, when the lever 43 turns in the clockwise direction in FIG. 15, the slide member 42 slides in the +X direction.

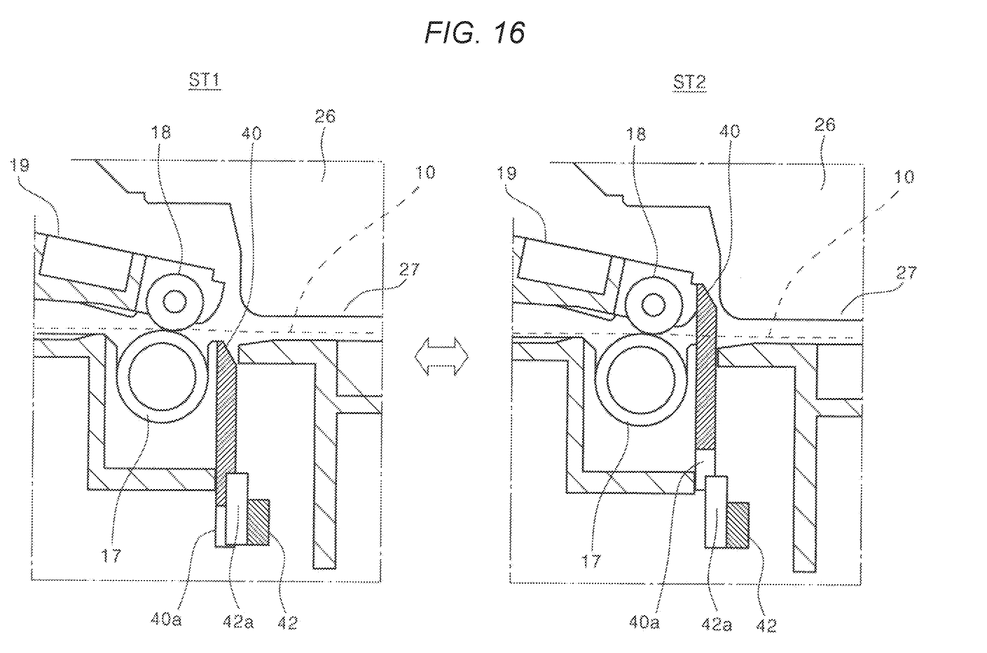

When the slide member 42 slides in the -X direction, the cam section 42a pushes up the fence 40 and the fence 40 takes the blocking state of blocking the conveyance path 10 (the state ST2 in FIG. 16). The -X direction is an example of a first direction in the medium width direction.

When the slide member 42 slides in the +X direction, the push-up of the fence 40 by the cam section 42a is released and the fence 40 falls to take the opening state of opening the conveyance path 10 (the state ST1 in FIG. 16). In the present embodiment, the fence 40 retracts to below the conveyance path 10 to take the opening state. The +X direction is an example of a second direction in the medium width direction.

In the present embodiment, when the fence 40 falls, the fence 40 falls with own weight thereof. However, a pressing member such as a spring that presses the fence 40 in the -Z direction may be provided such that the fence 40 falls using a pressing force of the pressing member.

The upper end portion of the lever 43 is present at a height position where the upper end of the lever 43 is capable of engaging with the carriage 26.

When the carriage 26 is separated from the lever 43, the lever 43 takes a vertical posture, the slide member 42 is located at a slide limit in the +X direction by the spring force of the compression coil spring 45, and the fence 40 takes the opening state. When the carriage 26 moves in the +X direction from this state and presses the upper end portion of the lever 43 in the +X direction, the lever 43 turns in the counterclockwise direction in FIG. 15, whereby the fence 40 rises and takes the blocking state. That is, when the carriage 26 moves to the outer side of the recording region where recording is performed on the medium, the slide member 42 receives an external force moving in the width direction from the carriage 26 and slides in the +X direction. In FIG. 15, the carriage 26 engaging with the lever 43 is indicated by an alternate long and two-short dashes line.

When the conveyance motor 56 is rotated in the reverse rotation direction in order to cause the suction pump 66 to operate, the control section 50 (see FIG. 3) moves the carriage 26 to the end portion in the +X direction in advance to switch the fence 40 from the opening state to the blocking state. That is, the control section 50 sets the fence 40 to the opening state when the conveyance motor 56 is driven in the forward rotation direction and sets the fence 40 to the blocking state when the conveyance motor 56 is driven in the reverse rotation direction.

With the configuration explained above, like the flap 35 explained above, it is possible to prevent the medium from being unintentionally sent upstream of the conveyance path 10, in particular, further upstream than the conveyance roller pair 16 and it is possible to prevent a jam from occurring.

In the present embodiment, like the flap 35 explained above, the fence 40 taking the blocking state blocks the medium between the recording head 27 and the conveyance roller pair 16 in the conveyance path 10. For this reason, it is possible to more securely stop the medium sent upstream of the conveyance path 10.

However, the fence 40 may be provided between the discharge roller pair 22 and the recording head 27.

In the present embodiment, the blocking section includes the fence 40 that moves in the direction intersecting the conveyance path 10, that is, in the Z-axis direction in the present embodiment to switch the opening state and the blocking state. For this reason, the blocking section can switch the opening state and the blocking state with a simple configuration.

In the present embodiment, when the slide member 42 moves in the first direction, that is, the -X direction, the cam section 42a pushes up the fence 40 to switch the fence 40 from the opening state to the blocking state. When the slide member 42 moves in the second direction, that is, the +X direction, the push-up of the fence 40 by the cam section 42a is released and the fence 40 is switched from the blocking state to the opening state.

With the configuration in which the fence 40 is switched to the opening state and the blocking state by the operation of the carriage 26 as explained above, a dedicated power source for raising and lowering the fence 40 is unnecessary and it is possible to suppress an increase in cost of the apparatus.

In FIGS. 14 and 15, the blocking state of the fence 40 is illustrated. In this case, the carriage 26 is located at the end portion in the +X direction. However, for convenience of illustration, a state in which the carriage 26 indicated by a solid line is located at the end portion in the -X direction, that is, a home position is illustrated.

Here, when the carriage 26 separates from the lever 43, the fence 40 is switched from the blocking state to the opening state. For this reason, when the suction pump 66 is caused to operate in the state in which the carriage 26 is located at the home position, the medium sent upstream of the conveyance path 10 cannot be stopped by the fence 40. Therefore, when the blocking state of the fence 40 is maintained regardless of the position of the carriage 26, for example, it is suitable to engage the lever 43 with a not-illustrated push latch mechanism. In this case, when the carriage 26 pushes the upper end portion of the lever 43 in the +X direction while the fence 40 is in the opening state, the state illustrated in FIG. 15, that is, the blocking state of the fence 40 is maintained by the push latch mechanism. When the carriage 26 pushes the upper end portion of the lever 43 in the +X direction in this state, the state illustrated in FIG. 15, that is, the blocking state of the fence 40 is released by the push latch mechanism and the fence 40 is switched to the opening state.

A configuration in which the slide member 42 is slid using an actuator such as a solenoid may be adopted. In this case, the state of the slide member 42 can be freely switched by the control of the control section 50 regardless of the position of the carriage 26.

The present disclosure is not limited to the embodiment and the modifications explained above and various modifications can be made within the scope of the disclosure set forth in the appended claims, and it is needless to say that these modifications also fall within the scope of the disclosure.

What is claimed is:

1. A recording apparatus comprising:
a conveyance path for conveying a medium;
a recording head configured to perform recording on the medium in the conveyance path;
a first roller pair provided upstream of the recording head in the conveyance path and configured to convey the medium;
a second roller pair provided downstream of the recording head in the conveyance path and configured to convey the medium;
a cap facing the recording head;
a suction pump coupled to the cap;
a motor that is a common driving source for the first roller pair, the second roller pair, and the suction pump;
a power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction; and
a blocking section provided between the first roller pair and the second roller pair in the conveyance path and switched to a blocking state of blocking the conveyance path and an opening state of opening the conveyance path, wherein
the blocking section takes the opening state when the motor rotates in the forward rotation direction and takes the blocking state when the motor rotates in the reverse rotation direction.

2. The recording apparatus according to claim 1, wherein the blocking section taking the blocking state blocks the medium between the recording head and the first roller pair in the conveyance path.

3. The recording apparatus according to claim 2, wherein
the first roller pair includes a drive roller to which power is transmitted and a driven roller that is driven to rotate while nipping the medium between the driven roller and the drive roller, and
the blocking section includes a flap that obtains torque from the drive roller or the driven roller and rotates to switch the opening state and the blocking state.

4. The recording apparatus according to claim 3, wherein the flap is disposed side by side with the driven roller along a rotation axis of the driven roller and obtains torque from the driven roller and rotates.

5. The recording apparatus according to claim 4, further comprising a support member configured to support the driven roller, wherein
the flap is provided in the support member.

6. The recording apparatus according to claim 5, further comprising:
a rotating member configured to rotate integrally with the driven roller and including a flange section; and
a spring member provided between the flap and the rotating member in a direction along the rotation axis, wherein
the flap receives torque from the driven roller via the spring member.

7. The recording apparatus according to claim 4, wherein the flap does not come into contact with the drive roller.

8. The recording apparatus according to claim 4, further comprising a facing section having a support surface that supports the medium, the facing section being provided at a position facing the recording head, wherein
the flap comes into contact with the support surface to take the blocking state when the motor rotates in the reverse rotation direction.

9. The recording apparatus according to claim 2, wherein the blocking section includes a fence that moves in a direction intersecting the conveyance path to switch the opening state and the blocking state.

10. The recording apparatus according to claim 9, further comprising:
a carriage movable in a width direction intersecting the conveyance direction of the medium and including the recording head; and
a slide member configured to receive an external force moving in the width direction from the carriage when the carriage moves to an outer side of a recording region where recording is performed on the medium, wherein
the fence retracts to below the conveyance path to take the opening state and rises from below the conveyance path to take the blocking state,
a cam section that pushes up the fence is provided in the slide member, and
when the slide member moves in a first direction in the width direction, the cam section pushes up the fence to switch the fence from the opening state to the blocking state and
when the slide member moves in a second direction opposite to the first direction, the cam section releases the push-up of the fence to switch the fence from the blocking state to the opening state.
